(19) United States
(12) Patent Application Publication
(10) Pub. No.: US 2011/0227951 A1
(43) Pub. Date: Sep. 22, 2011

(54) CONFERENCE SYSTEM, INFORMATION PROCESSING APPARATUS, DISPLAY METHOD, AND NON-TRANSITORY COMPUTER-READABLE RECORDING MEDIUM ENCODED WITH DISPLAY PROGRAM

(75) Inventors: Hiroaki KUBO, Muko (JP); Kaitaku Ozawa, Itami-shi (JP); Jun Kunioka, Kawanishi-shi (JP); Ayumi Itoh, Ikoma-gun (JP)

(73) Assignee: Konica Minolta Business Technologies, Inc., Tokyo (JP)

(21) Appl. No.: 13/049,658

(22) Filed: Mar. 16, 2011

(30) Foreign Application Priority Data
Mar. 18, 2010 (JP) 2010-062023

(51) Int. Cl. G09G 5/00

(52) U.S. Cl. 345/667; 345/682

(57) ABSTRACT

A conference system includes a display apparatus and an information processing apparatus communicable with the display apparatus. The information processing apparatus includes a portion to acquire a source content, a display control portion to cause the display apparatus to display the acquired source content, a portion to extract subcontents included in the acquired source content, a portion to determine a target subcontent from among the extracted subcontents, a portion to accept an input content input externally, and a portion to generate a modified content in which an insert area for arranging the input content therein is added at a position in the source content that is determined with reference to a position where the target subcontent is located. The display control portion causes the display apparatus to display an image in which the input content is arranged in the added insert area in the modified content.

This application is based on Japanese Patent Application No. 2010-062023 filed with Japan Patent Office on Mar. 18, 2010, the entire content of which is hereby incorporated by reference.

### BACKGROUND OF THE INVENTION

1. Field of the Invention

The present invention relates to a conference system, an information processing apparatus, a display method, and a non-transitory computer-readable recording medium encoded with a display program. More particularly, the present invention relates to a conference system and an information processing apparatus which each allow information such as a memorandum to be readily added to an image displayed, a display method which is executed by the information processing apparatus, and a non-transitory computer-readable recording medium encoded with a display program which is executed by the information processing apparatus.

2. Description of the Related Art

In a conference and the like, images of materials prepared in advance are displayed on a screen to be used for explanation during presentation. In recent years, it is often the case that a presenter stores explanatory materials in a personal computer (PC) used by him/herself, and connects a projector or the like serving as a display device to the presenter's PC so as to cause the material images output from the presenter's PC to be displayed by the projector. It is also possible that a conference participant causes a PC used by him/herself to receive display data transmitted from the presenter's PC so as to cause the same image as that displayed by the projector to be displayed on the participant's PC. Furthermore, a technique is known which allows a presenter or a participant to input a memorandum such as a handwritten character so that the memorandum is stored in association with the image displayed.

Japanese Patent Laid-Open No. 2003-009107 discloses a terminal for electronic conference, which is configured to add memorandum information written by a conference participant to a distributed material file for a conference. The terminal includes: document information storing means for storing displayed information out of the distributed material file with the progress of the conference; input means for accepting an input of the memorandum information or the like from the participant; memorandum information storing means for storing the memorandum information; displayed information storing means for storing a screen in which storage contents of the document information storing means and storage contents of the memorandum information storing means are overlapped with each other; display means for displaying the storage contents of the displayed information storing means; and file writing means for generating the distributed material file with the memorandum, from the displayed information in which the storage contents of the document information storing means and the storage contents of the memorandum information storing means are overlapped with each other.

With the conventional terminal for electronic conference described above, however, the screen in which displayed information and memorandum information are overlapped with each other is displayed and stored, causing the memorandum information to be overlaid on the displayed information, hindering discrimination between the two types of information. The problem is serious particularly when the displayed information is not provided with enough space for writing a memorandum therein.

Japanese Patent Laid-Open No. 2007-280235 discloses an electronic conference support device, which includes: cut screen information management means for storing, in a storage device, information regarding a cut screen object which forms a part of a screen image displayed on presenter-side display means; screen image generation processing means for generating a screen image on the basis of information regarding a cut screen object designated from among cut screen objects contained in a screen image displayed on participant-side display means, by acquiring the relevant information from the cut screen information management means and incorporating, while referring to the acquired information, the designated cut screen object into image data to be newly displayed on the participant-side display means; and edit screen information storage means for storing information regarding the screen image generated by the screen image generation processing means in association with information regarding the cut screen object incorporated into the screen image.

With the conventional electronic conference support device described above, however, a part of a screen image displayed is cut out to display a new image. This means that an original image is changed.

### SUMMARY OF THE INVENTION

The present invention has been accomplished in view of the foregoing problems, and an object of the present invention is to provide a conference system which is able to place an input content on a source content such that they do not overlap each other, without changing information included in the source content.

Another object of the present invention is to provide an information processing apparatus which is able to place an input content on a source content such that they do not overlap each other, without changing information included in the source content.

A further object of the present invention is to provide a display method and a non-transitory computer-readable recording medium encoded with a display program which both enable placement of an input content on a source content such that they do not overlap each other, without changing information included in the source content.

In order to achieve the above-described objects, according to an aspect of the present invention, there is provided a conference system including a display apparatus and an information processing apparatus capable of communicating with the display apparatus, wherein the information processing apparatus includes: a source content acquiring portion to acquire a source content; a display control portion to cause the display apparatus to display the acquired source content; a subcontent extracting portion to extract a plurality of subcontents included in the acquired source content; a process target determining portion to determine a target subcontent from among the plurality of extracted subcontents; an input content accepting portion to accept an input content input externally; and a content modifying portion to generate a modified content in which an insert area for arranging the input content therein is added at a position in the source content that is determined with reference to a position where the target subcontent is located; and wherein the display control portion causes the display apparatus to display an image in which the input content is arranged in the added insert area in the modified content.

According to another aspect of the present invention, there is provided an information processing apparatus capable of communicating with a display apparatus, wherein the information processing apparatus includes: a source content acquiring portion to acquire a source content; a display control portion to cause the display apparatus to display the acquired source content; a subcontent extracting portion to extract a plurality of subcontents included in the acquired source content; a process target determining portion to determine a target subcontent as a process target from among the plurality of extracted subcontents; an input content accepting portion to accept an input content input externally; and a content modifying portion to generate a modified content in which an insert area for arranging the input content therein is added at a position in the source content that is determined with reference to a position where the target subcontent is located; and wherein the display control portion causes the display apparatus to display an image in which the input content is arranged in the added insert area in the modified content.

According to a further aspect of the present invention, there is provided a display method executed by an information processing apparatus capable of communicating with a display apparatus, wherein the method includes steps of acquiring a source content; causing the display apparatus to display the acquired source content; extracting a plurality of subcontents included in the acquired source content; determining a target subcontent as a process target from among the plurality of extracted subcontents; accepting an input content input externally; generating a modified content in which an insert area for arranging the input content therein is added at a position in the source content that is determined with reference to a position where the target subcontent is located; and causing the display apparatus to display an image in which the input content is arranged in the added insert area in the modified content.

According to yet another aspect of the present invention, there is provided a non-transitory computer-readable recording medium encoded with a display program executed by a computer controlling an information processing apparatus, the information processing apparatus capable of communicating with a display apparatus, wherein the display program causes the computer to execute processing including steps of acquiring a source content; causing the display apparatus to display the acquired source content; extracting a plurality of subcontents included in the acquired source content; determining a target subcontent as a process target from among the plurality of extracted subcontents; accepting an input content input externally; generating a modified content in which an insert area for arranging the input content therein is added at a position in the source content that is determined with reference to a position where the target subcontent is located; and causing the display apparatus to display an image in which the input content is arranged in the added insert area in the modified content.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an example of a conference system according to a first embodiment of the present invention;

FIG. 2 is a block diagram showing an example of the hardware configuration of an MFP;

FIG. 3 is a block diagram schematically showing the functions of a CPU included in the MFP;

FIG. 4 is a first diagram showing an example of the relationship between display data and a display area;

FIG. 5 is a first diagram showing an example of a modified content;

FIG. 6 is a second diagram showing an example of the relationship between the display data and the display area;

FIG. 7 is a second diagram showing an example of the modified content;

FIG. 8 is a third diagram showing an example of the modified content;

FIG. 9 is a fourth diagram showing an example of the modified content;

FIG. 10 shows a flowchart illustrating an example of the flow of display processing;

FIG. 11 is a flowchart illustrating an example of the flow of a process of generating a modified content;

FIG. 12 is a block diagram schematically showing the functions of the CPU included in the MFP according to a second embodiment of the present invention;

FIG. 13 shows an example of display data and picked-up images;

FIG. 14 is a fifth diagram showing an example of the modified content;

FIG. 15 shows a second flowchart illustrating an example of the flow of the display processing;

FIG. 16 is a third diagram showing an example of the relationship between the display data and the display area;

FIG. 17 is a sixth diagram showing an example of the modified content;

FIG. 18 shows an example of display data and a hand-drawn image; and

FIG. 19 is a seventh diagram showing an example of the modified content.

### DESCRIPTION OF THE PREFERRED EMBODIMENTS

Embodiments of the present invention will now be described with reference to the drawings. In the following description, like reference characters denote like members, which have like names and functions, and therefore, detailed description thereof will not be repeated.

### First Embodiment

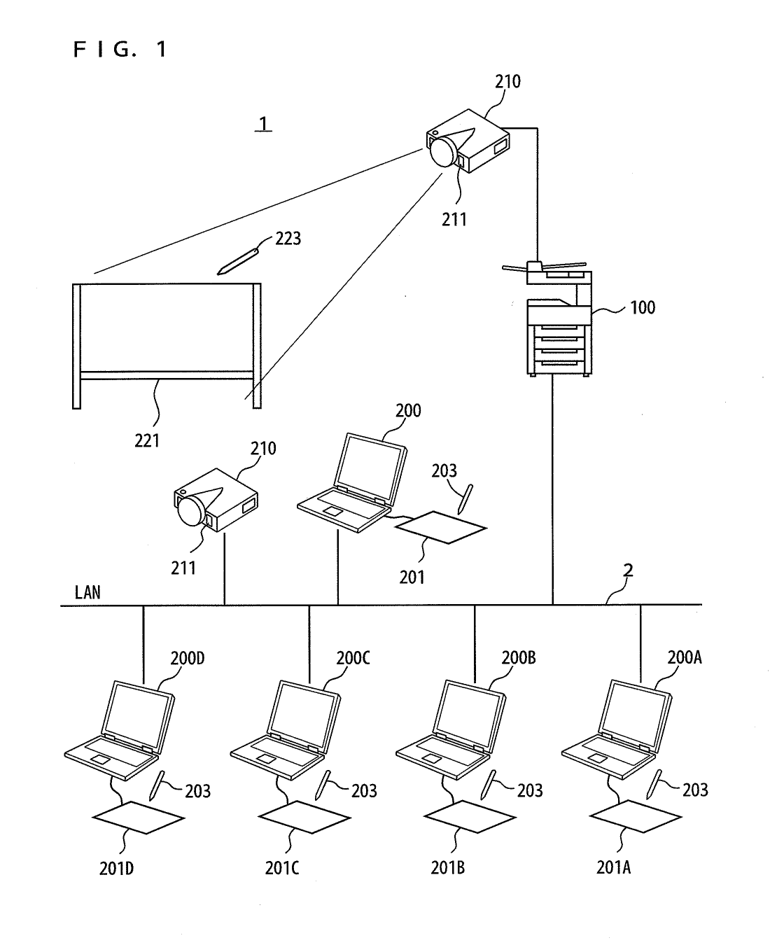

FIG. 1 shows an example of a conference system according to a first embodiment of the present invention. Referring to FIG. 1, a conference system 1 includes a multi-function peripheral (hereinafter, referred to as “MFP”) 100, a plurality of personal computers (hereinafter, referred to as “PCs”) 200 and 200A to 200D, a camera-equipped projector 210, and a whiteboard 221. MFP 100, PCs 200 and 200A to 200D, and camera-equipped projector 210 are each connected to a local area network (hereinafter, referred to as “LAN”) 2.

MFP 100, which is an example of an information processing apparatus, includes a plurality of functions such as the scanner function, function as a printer, copying function, and facsimile transmitting/receiving function. MFP 100 is able to communicate with camera-equipped projector 210 and PCs 200 and 200A to 200D through LAN 2. Although MFP 100, PCs 200 and 200A to 200D, and camera-equipped projector 210 are connected with each other through LAN 2 in this example, they may be connected through serial communication cables or parallel communication cables as long as they can communicate with each other. The communication may be wired or wireless.

With conference system 1 according to the present embodiment, a presenter in a conference causes MFP 100 to store a presentation material as a source content therein. The source content may be data which can be displayed by a computer, such as an image, a character, a chart or graph, or a combination thereof. It is here assumed that the source content is a page of data containing an image.

MFP 100 functions as a display control apparatus, which controls camera-equipped projector 210 to project an image constituting at least a part of the source content, to thereby cause an image to be displayed on whiteboard 221. Specifically, MFP 100 determines at least a part of the source content as a display area, and transmits the image of the display area as a display image to camera-equipped projector 210 to cause camera-equipped projector 210 to display the display image. The display image is identical in size to an image which camera-equipped projector 210 can display. Therefore, in the case where the entirety of a source content is greater in size than the display image, a part of the source content is set as the display area. In the case where the entirety of a source content is smaller in size than the display image, the entirety of the source content is set as the display area.

It is noted that MFP 100 may cause camera-equipped projector 210 to display the display image by transmitting a source content from MFP 100 to camera-equipped projector 210 in advance and remotely controlling camera-equipped projector 210 therefrom. In this case as well, at least a part of the source content is set as a display area, so that the display image of the display area of the source content is displayed. The format of the display image transmitted from MFP 100 to camera-equipped projector 210 is not limited to a particular one, as long as camera-equipped projector 210 can receive and interpret the image.

Camera-equipped projector 210 includes a liquid crystal display, a lens, and a light source, and projects a display image received from MFP 100 onto a drawing surface of whiteboard 221. Specifically, the liquid crystal display displays a display image, and the light emitted from the light source transmits through the liquid crystal display and is emitted onto whiteboard 221 via the lens. When the light emitted from camera-equipped projector 210 reaches the drawing surface of whiteboard 221, a magnified version of the display image displayed on the liquid crystal display is thrown onto the drawing surface. Herein, the drawing surface of whiteboard 221 corresponds to a projection surface onto which camera-equipped projector 210 projects a display image.

Camera-equipped projector 210 further includes a camera 211, and outputs a picked-up image which is picked up by camera 211. MFP 100 controls camera-equipped projector 210 to pick up an image displayed on the drawing surface of whiteboard 221, and acquires the picked-up image output from camera-equipped projector 210. For example, in the case where a presenter or a participant in the conference draws a character or the like freehand on a drawing surface of the whiteboard to add an image to the display image which is being displayed, the picked-up image output from camera-equipped projector 210 is an image of the display image that includes the hand-drawn image.

PCs 200 and 200A to 200D are typical computers. Their hardware configurations and functions are well known in the art, and thus, description thereof will not be provided here. Here, MFP 100 transmits to PCs 200 and 200A to 200D the same display image as the one MFP 100 is causing camera-equipped projector 210 to display. Thus, the display image which is the same as the one being displayed on whiteboard 221 is displayed on a display of each of PCs 200 and 200A to 200D. As a result, a user of any of PCs 200 and 200A to 200D can confirm the progress of the conference while seeing the display image displayed on whiteboard 221 or any of the displays of PCs 200 and 200A to 200D.

Further, touch panels 201, 201A, 201B, 201C, and 201D are connected to PCs 200, 200A, 200B, 200C, and 200D, respectively. Users of PCs 200 and 200A to 200D can use touch pens 203 to input a handwritten character to the corresponding ones of touch panels 201, 201A, 201B, 201C, and 201D. Each of PCs 200 and 200A to 200D transmits a hand-drawn image including the handwritten character input into the corresponding one of touch panels 201, 201A, 201B, 201C, and 201D, to MFP 100.

When receiving a hand-drawn image from one of PCs 200 and 200A to 200D, MFP 100 combines the hand-drawn image with the display image that had been output to camera-equipped projector 210 till then to generate a composite image, and output the composite image to camera-equipped projector 210 to cause it to display the composite image. As a result, the hand-drawn image drawn freehand by a participant using one of PCs 200 and 200A to 200D is displayed on whiteboard 221.

It is noted that whiteboard 221 may be configured to have a touch panel on a drawing surface thereof, and whiteboard 221 may be connected to MFP 100 via LAN 2. In this case, when the drawing surface of whiteboard 221 is designated by a pen or the like, whiteboard 221 acquires as positional information the coordinates of the position on the drawing surface designated by the pen, and transmits the positional information to MFP 100. As a user draws a character or a graphic on the drawing surface of whiteboard 221 with a pen, the positional information including all the coordinates included in one or more lines constituting the character or the graphic drawn on the drawing surface is transmitted to MFP 100. Thus, MFP 100 can use the positional information to compose a hand-drawn image of the character or the graphic drawn on whiteboard 221 by the user. MFP 100 processes the hand-drawn image drawn on whiteboard 221 in the same manner as the hand-drawn image input from any of PCs 200 and 200A to 200D described above.

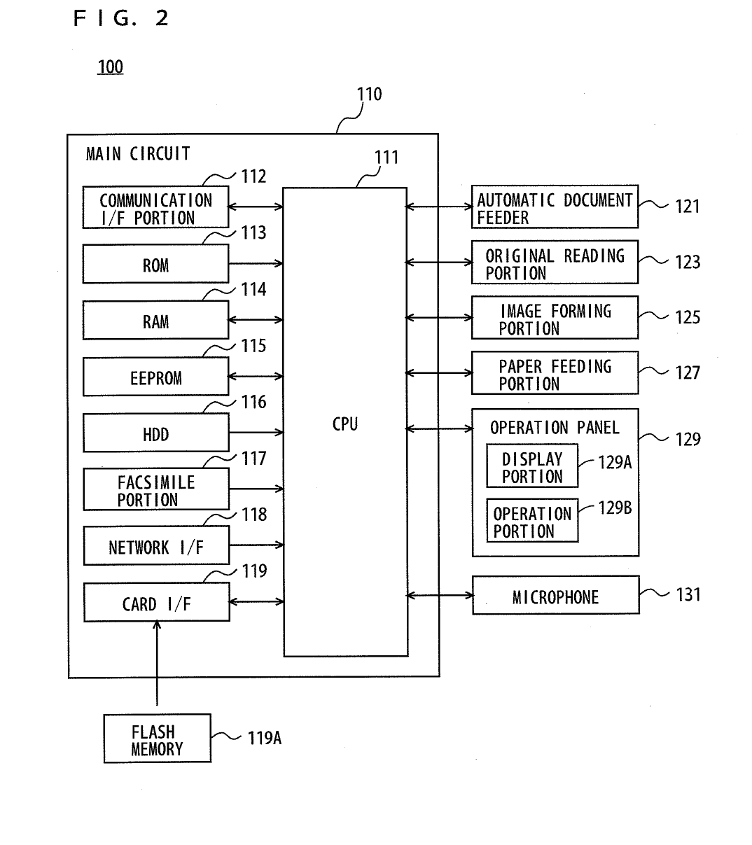

FIG. 2 is a block diagram showing an example of the hardware configuration of the MFP. Referring to FIG. 2, MFP 100 includes: a main circuit 110; an original reading portion 123 which reads an original; an automatic document feeder 121 which delivers an original to original reading portion 123; an image forming portion 125 which forms, on a sheet of paper or the like, a still image output from original reading portion 123 that read an original; a paper feeding portion 127 which supplies sheets of paper to image forming portion 125; an operation panel 129 serving as a user interface; and a microphone 131 which collects sound.

Main circuit 110 includes a central processing unit (CPU) 111, a communication interface (I/F) portion 112, a read only memory (ROM) 113, a random access memory (RAM) 114, an electrically erasable and programmable ROM (EEPROM) 115, a hard disk drive (HDD) 116 as a mass storage, a facsimile portion 117, a network interface (I/F) 118, and a card interface (I/F) 119 mounted with a flash memory 119A. CPU 111 is connected with automatic document feeder 121, original reading portion 123, image forming portion 125, paper feeding portion 127, and operation panel 129, and is responsible for overall control of MFP 100.

ROM 113 stores a program executed by CPU 111 as well as data necessary for execution of the program. RAM 114 is used as a work area when CPU 111 executes a program.

Operation panel 129 is provided on an upper surface of MFP 100, and includes a display portion 129A and an operation portion 129B. Display portion 129A is a display such as a liquid crystal display or an organic electro-luminescence display (ELD), and displays an instruction menu for the user, information about acquired display data, and others. Operation portion 129B is provided with a plurality of keys, and accepts input of data such as instructions, characters, and numerical characters, according to the key operations of the user. Operation portion 129B further includes a touch panel provided on display portion 129A.

Communication I/F portion 112 is an interface for connecting MFP 100 to another device via a serial communication cable. It is noted that the connection may be wired or wireless.

Facsimile portion 117 is connected to public switched telephone networks (PSTN), and transmits facsimile data to or receives facsimile data from the PSTN. Facsimile portion 117 stores the received facsimile data in HDD 116, or outputs it to image forming portion 125. Image forming portion 125 prints the facsimile data received by facsimile portion 117 on a sheet of paper. Further, facsimile portion 117 converts the data stored in HDD 116 to facsimile data, and transmits it to a facsimile machine connected to the PSTN.

Network I/F 118 is an interface for connecting MFP 100 to LAN 2. CPU 111 is capable of communicating with PCs 200 and 200A to 200D and camera-equipped projector 210, which are connected to LAN 2, via network I/F 118. When LAN 2 is connected to the Internet, CPU 111 is capable of communicating with computers connected to the Internet. The computers connected to the Internet include an e-mail server which transmits and receives e-mail. The network to which network I/F 118 is connected is not restricted to LAN 2. It may be the Internet, a wide area network (WAN), public switched telephone networks (PSTN), or the like.

Microphone 131 collects sound and outputs the collected sound to CPU 111. It is here assumed that MFP 100 is set up in a conference room and microphone 131 collects sound in the conference room. It is noted that microphone 131 may be connected to MFP 100, wired or wireless, to allow a presenter or a participant in the conference room to input voice to microphone 131. In this case, MFP 100 need not be set up in the conference room.

Card I/F 119 is mounted with flash memory 119A. CPU 111 is capable of accessing flash memory 119A via card I/F 119. CPU 111 is capable of loading a program stored in flash memory 119A, to RAM 114 for execution. It is noted that the program executed by CPU 111 is not restricted to the program stored in flash memory 119A. It may be a program stored in another storage medium or in HDD 116. Further, it may be a program written into HDD 116 by another computer connected to LAN 2 via communication I/F portion 112.

The storage medium for storing a program is not restricted to flash memory 119A. It may be an optical disc (magneto-optical (MO) disc, mini disc (MD), digital versatile disc (DVD)), an IC card, an optical card, or a semiconductor memory such as a mask ROM, an erasable and programmable ROM (EPROM), an EEPROM, or the like.

As used herein, the “program” includes, not only the one directly executable by CPU 111, but also a source program, a compressed program, an encrypted program, and others.

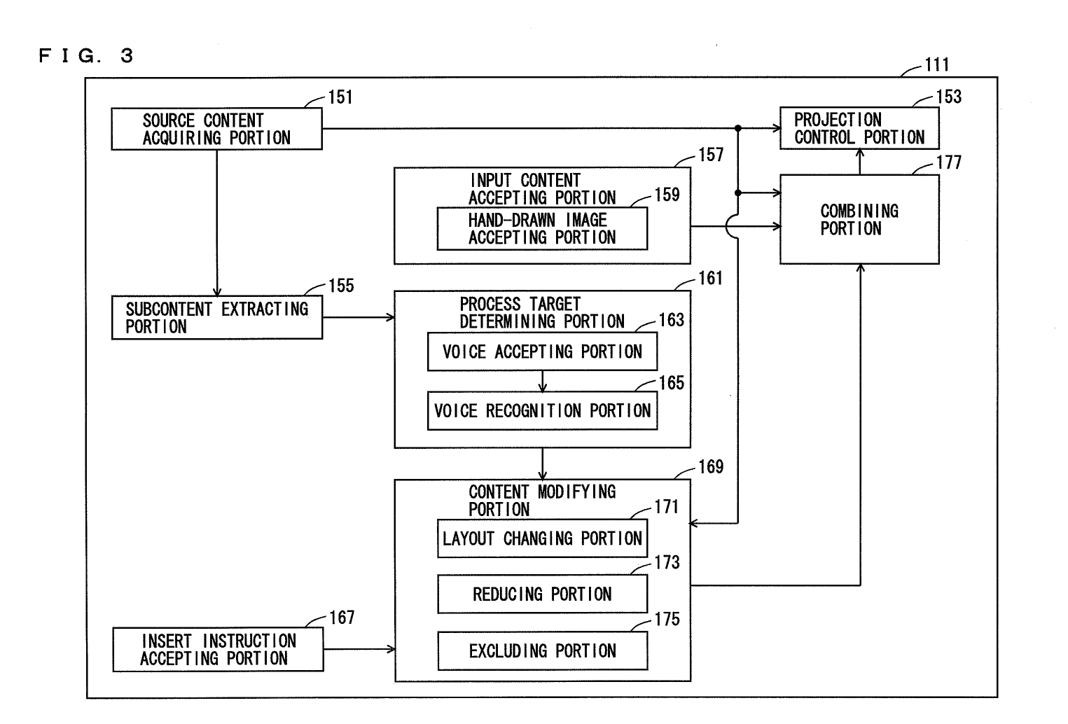

FIG. 3 is a block diagram schematically showing the functions of the CPU included in the MFP. The functions shown in FIG. 3 are implemented as CPU 111 included in MFP 100 executes a display program stored in ROM 113 or flash memory 119A. Referring to FIG. 3, the functions implemented by CPU 111 include: a source content acquiring portion 151 which acquires a source content; a projection control portion 153 which controls a camera-equipped projector; a subcontent extracting portion 155 which extracts subcontents included in a source content; a process target determining portion 161 which determines a target subcontent to be processed, from among a plurality of subcontents; an input content accepting portion 157 which accepts an input content input from the outside; an insert instruction accepting portion 167 which accepts an insert instruction input by a user; a content modifying portion 169 which generates a modified content; and a combining portion 177.

Source content acquiring portion 151 acquires a source content. Here, as an example of the source content, display data stored in advance as presentation data in HDD 116 will be described. Specifically, display data created as presentation materials by a presenter is stored in HDD 116 in advance. Then, when the presenter operates operation portion 129B to input an operation for designating the display data, source content acquiring portion 151 reads the designated display data from HDD 116 to acquire the display data. Source content acquiring portion 151 outputs the acquired display data to projection control portion 153, subcontent extracting portion 155, content modifying portion 169, and combining portion 177.

Projection control portion 153 sets at least a part of the display data input from source content acquiring portion 151 as a display area, and outputs an image of the display area as a display image to camera-equipped projector 210, to cause it to display the display image. It is here assumed that the display data includes a one-page image. Thus, an image of the display area in the display data that is specified by an operation input to operation portion 129B by the presenter is output as a display image to camera-equipped projector 210. In the case where an image of the display data is greater in size than the image that can be projected by camera-equipped projector 210, a part of the display data is output as a display area to camera-equipped projector 210 so as to be projected thereby. In this case, when the presenter inputs a scroll operation to operation portion 129B, projection control portion 153 modifies the display area of the display data.

In the case where projection control portion 153 receives a composite image from combining portion 177, as will be described later, projection control portion 153 sets at least a part of the composite image as a display area, and outputs an image of the display area as a display image to camera-equipped projector 210 to cause it to display the display image. In the case where the composite image is greater in size than the image that can be projected by camera-equipped projector 210, projection control portion 153 modifies the display area of the composite image in accordance with a scroll operation input by the presenter, as in the case of the display data described above.

Subcontent extracting portion 155 extracts one or more subcontents included in the display data received from source content acquiring portion 151. A subcontent refers to a group of character strings, a graphic, an image, or the like included in a source content which is here the display data. In other words, a subcontent is an area surrounded by blank areas in a source content. There is a blank area between two subcontents adjacent to each other. To extract a subcontent, for example, an image of a source content is horizontally and vertically divided into a plurality of blocks. Then, an attribute is determined for each block, and neighboring blocks with the same attribute are grouped into a subcontent, which is in turn extracted. The attribute may include a character attribute which represents a character, a graphic attribute which represents a line image such as a graph, and a photographic attribute which represents a photograph. When a plurality of subcontents are extracted from a source content, there may be two or more subcontents with the same attribute, or all the subcontents may have different attributes. Subcontent extracting portion 155 outputs a set of the extracted subcontent and the positional information indicating the position of that subcontent in the source content, to process target determining portion 161.

In the case where subcontent extracting portion 155 extracts two or more subcontents, it pairs each of the plurality of subcontents with its positional information and outputs the plurality of sets to process target determining portion 161. As the source content herein is display data including a one-page image, the positional information indicating the position of a subcontent in a source content is represented by the coordinates of the barycenter of the area occupied by the subcontent in the display data. In the case where the display data as the source content includes a plurality of pages of page data, the positional information is represented by a page number and the coordinates of the barycenter of the area occupied by the subcontent in the page data corresponding to that page number.

Input content accepting portion 157 includes a hand-drawn image accepting portion 159. When communication I/F portion 112 receives a hand-drawn image from one of PCs 200 and 200A to 200D, hand-drawn image accepting portion 159 accepts the received hand-drawn image. Hand-drawn image accepting portion 159 outputs the accepted hand-drawn image to combining portion 177. It is noted that the input content accepted by input content accepting portion 157 is not necessarily a hand-drawn image, which may be a character string or an image. While it is here assumed that the input content is a hand-drawn image transmitted from one of PCs 200 and 200A to 200D, it may be an image that original reading portion 123 of MFP 100 acquires by reading an original, or data stored in HDD 116.

In the case where process target determining portion 161 receives a plurality of subcontents from subcontent extracting portion 155, process target determining portion 161 determines a target subcontent to be processed, from among the plurality of subcontents. Process target determining portion 161 includes a voice accepting portion 163 and a voice recognition portion 165. Process target determining portion 161 enables voice accepting portion 163 and voice recognition portion 165 when an automatic audio tracing function is ON. The automatic audio tracing function is set to ON or OFF according to a user's setting in MFP 100 performed in advance.

Voice accepting portion 163 accepts voice collected by and output from microphone 131. Voice accepting portion 163 outputs the accepted voice to voice recognition portion 165. Voice recognition portion 165 recognizes the input voice to output a character string. Process target determining portion 161 compares the character string output from voice recognition portion 165 with a plurality of character strings included respectively in different subcontents to determine, as a target subcontent, the subcontent including the same character string as that output from voice recognition portion 165.

A presenter would utter by referring to the display image projected on whiteboard 221, and a participant would utter by looking at the display image. Therefore, it is highly likely that a subcontent including the word uttered by a presenter or a participant is an issue currently discussed by the participants in the conference. Thus, when the automatic audio tracing function is set to ON, the target subcontent is changed with the progress of the conference. Whenever the target subcontent is changed, process target determining portion 161 outputs the positional information of a new target subcontent to content modifying portion 169. As described above, the positional information of a subcontent is information for specifying the location of the subcontent in a source content and is represented by the coordinates in the source content.

When the automatic audio tracing function is set to OFF, process target determining portion 161 displays on display portion 129A the same display image as that which projection control portion 153 is outputting to camera-equipped projector 210. When a user inputs an arbitrary position in the display image to operation portion 129B, process target determining portion 161 accepts the input position as a designated position, and determines and sets the subcontent located at the designated position in the display image as a target subcontent. Process target determining portion 161 outputs the positional information of the determined target subcontent to content modifying portion 169.

It is noted that a user of one of PCs 200 and 200A to 200D may input a designated position by remotely operating MFP 100. In this case, when communication I/F portion 112 receives the designated position from one of PCs 200 and 200A to 200D, process target determining portion 161 accepts the designated position.

Content modifying portion 169 receives display data from source content acquiring portion 151, positional information of a target subcontent from process target determining portion 161, and an insert instruction from insert instruction accepting portion 167. When a user presses a key predetermined in operation portion 129B, insert instruction accepting portion 167 accepts the insert instruction. When accepting the insert instruction, insert instruction accepting portion 167 outputs the insert instruction to content modifying portion 169. It is noted that a user of one of PCs 200 and 200A to 200D may input an insert instruction by remotely operating MFP 100. In this case, when communication I/F portion 112 receives an insert instruction from one of PCs 200 and 200A to 200D, insert instruction accepting portion 167 accepts the insert instruction. Still alternatively, insert instruction accepting portion 167 may accept an insert instruction when voice recognition portion 165 outputs a predetermined character string, such as “insert instruction”.

Content modifying portion 169, on receipt of an insert instruction, generates a modified content in which an insert area for arranging an input content therein is added at a position in the display data that is determined with reference to the position where the target subcontent is located. Specifically, content modifying portion 169 specifies a target subcontent from among subcontents included in the display data, in accordance with the positional information that was received from process target determining portion 161 immediately before the reception of the insert instruction. Content modifying portion 169 then determines a layout position around the target subcontent.

The layout position is determined by the position of the target subcontent in a display image. For example, when the target subcontent is located in an upper half of the display image, the layout position is determined as a position immediately below the target subcontent. When the target subcontent is located in a lower half of the display image, the layout position is determined as a position immediately above the target subcontent. It is noted that the layout position may be set anywhere around the target subcontent, i.e. above or below, or on the right or left of the target subcontent.

While it is here assumed that the layout position is determined in the vertical direction of the target subcontent, the direction of the layout position may be determined in accordance with the direction in which a plurality of subcontents included in the display area of the display data (i.e. the source content) are arrayed. In the case where the subcontents included in the display area of the display data are arrayed horizontally, the layout position may be determined as a position on the right or left of the target subcontent.

Here, description will be made about the case where the layout position is determined as a position immediately below the target subcontent. Content modifying portion 169 outputs to combining portion 177 the modified content generated, and its insert position which is the position of the barycenter of the insert area. Determining the layout position in proximity to the target subcontent helps clearly show the relationship between the target subcontent and an image included in the insert area, which will be described later.

Content modifying portion 169 includes a layout changing portion 171, a reducing portion 173, and an excluding portion 175. Content modifying portion 169 checks blank areas included in a display area that is set to be displayed among the display data, or, the source content. When the blank areas in the display area has a total height of not less than a threshold value T1, content modifying portion 169 enables layout changing portion 171. When the blank areas in the display area has a total height of less than the threshold value T1 and not less than a threshold value T2, content modifying portion 169 enables reducing portion 173. When the blank areas in the display area has a total height of less than the threshold value T2, content modifying portion 169 enables excluding portion 175. Here, the threshold value T1 is greater than threshold value T2.

Layout changing portion 171 generates a modified content by changing the layout of a plurality of subcontents included in the display area of the display data. Specifically, of the plurality of subcontents included in the display area of the display data, layout changing portion 171 moves upward any subcontent located above the layout position and moves downward any subcontent located below the layout position, thereby securing a blank area as an insert area immediately below the target subcontent. Layout changing portion 171 changes the layout of the plurality of subcontents included in the display area of the display data by moving the subcontents, within the display area, in descending order of distance from the layout position. As the layout of the subcontents within the display area is changed, the number of subcontents included in the display area is not changed before and after the change of layout of the subcontents. In other word, the subcontents displayed are not changed before and after the generation of the modified content. Accordingly, even when the modified content is displayed, the information displayed in the display area remains the same as that originally displayed therein.

Specifically, of the subcontents included in the display area of the display data, the subcontent located at the highest position is placed at the top of the display area, and the subcontent located at the lowest position is placed at the bottom of the display area. A distance to be secured between neighboring two subcontents after a change of the layout is predetermined, and the remaining subcontents are placed one by one above the subcontent placed at the bottom on one hand, and placed one by one below the subcontent placed at the top on the other hand, with the predetermined distance secured between the respective two subcontents. In other word, the layout of the plurality of subcontents included in the display area of the display data is changed within the display area by reducing the distance between the subcontents.

Layout changing portion 171 generates the modified content by changing the layout of the subcontents included in the display area of the display data (i.e. the source content), so that in the modified content, a blank area is secured at the layout position. Layout changing portion 171 sets that blank area secured in the modified content as an insert area. Layout changing portion 171 then sets the coordinates of the barycenter of the insert area as an insert position, and outputs the modified content and the insert position to combining portion 177.

Reducing portion 173 generates a modified content by reducing the size of a plurality of subcontents included in the display area of the display data, or, the source content. Specifically, reducing portion 173 reduces the size of the subcontents included in the display area of the display data, and then moves upward any subcontent, reduced in size, located above the layout position and moves downward any subcontent, reduced in size, located below the layout position, thereby securing a blank area as an insert area immediately below the target subcontent. While reducing portion 173 is different from layout changing portion 171 described above in that it reduces the size of the subcontents included in the display area of the display data, reducing portion 173 is identical to layout changing portion 171 in that it changes the layout of the subcontents, reduced in size, within the display area. Reducing portion 173 sets the coordinates of the barycenter of the insert area as an insert position, and outputs the modified content and the insert position to combining portion 177.

As the subcontents included in the display area of the display data (i.e. the source content) are reduced in size and then moved, the number of subcontents included in the display area is not changed before and after the change of the layout of the subcontents. In other word, the subcontents displayed are not changed before and after the generation of the modified content. Accordingly, even when the modified content is displayed, the information displayed in the display area remains the same as that originally displayed therein, although the subcontents are reduced in size.

Excluding portion 175 generates a modified content in which at least one of a plurality of subcontents included in the display area of the display data, i.e. the source content, is excluded from the display area. Specifically, excluding portion 175 specifies, from among the subcontents included in the display area of the display data, a subcontent that is farthest from the layout position, and places the specified subcontent outside of the display area. For the remaining subcontents, excluding portion 175 moves upward any subcontent located above the layout position and moves downward any subcontent located below the layout position, thereby securing a blank area as an insert area immediately below the target subcontent.

While excluding portion 175 is different from layout changing portion 171 described above in that it places at least one of the subcontents included in the display area of the display data outside of the display area, excluding portion 175 is identical to layout changing portion 171 in that it changes the layout of the remaining subcontents in the display area. Excluding portion 175 sets the blank area secured in the layout position in the modified content as an insert area, and sets the coordinates of the barycenter of the insert area in the modified content as an insert position. Excluding portion 175 then outputs the modified content generated and the insert position to combining portion 177. While excluding portion 175 is configured to place at least one of the subcontents included in the display area of the display data outside of the display area and then change the layout of the remaining subcontents as in layout changing portion 171, excluding portion 175 may further be configured to reduce the size of the remaining subcontents within the display area before changing the layout thereof, as in reducing portion 173.

As described above, at least one of the subcontents included in the display area of the display data, i.e. the source content, is placed outside of the display area, and then the layout of the remaining subcontents is changed within the display area. This means that at least the area within the display area that had been occupied by the subcontent before the same was moved to the outside of the display area can be used as the insert area.

In the case of placing a subcontent outside of the display area, if the size of the display data is fixed, excluding portion 175 adds a new page of page data to the display data so as to precede or succeed the page data that is being processed, and then places at least one of the subcontents included in the display data in the new page of page data. In the case where the subcontent to be placed outside of the display area is located in an upper part of the display area, excluding portion 175 adds the new page of page data so as to precede the display data, and causes the subcontent located at the highest position in the display data to be placed in the new page of page data. In the case where the subcontent to be placed outside of the display area is located in a lower part of the display area, excluding portion 175 adds the new page of page data so as to succeed the display data, and causes the subcontent located at the lowest position in the display data to be placed in the new page of page data. Alternatively, it may be configured such that the subcontent to be placed outside of the display area is placed in the new page of page data.

Combining portion 177 receives a source content from source content acquiring portion 151, a modified content and its insert position from content modifying portion 169, and an input content from input content accepting portion 157. The modified content refers to a content in which an insert area has been added to the display area of the display data, and the input content refers to a hand-drawn image. Combining portion 177 generates a composite image in which the hand-drawn image is disposed in the insert area specified by the insert position in the modified content. Combining portion 177 then sets at least a part of the composite image as a display area, and outputs a display image of the display area to projection control portion 153. Furthermore, combining portion 177 stores in HDD 116 the source content, the modified content, the insert position, and the input content, in association with one another. Storing the source content, the modified content, the insert position, and the input content in association with one another allows a composite image to be reproduced therefrom afterwards.

Projection control portion 153, on receipt of a new display image, displays the new display image in place of the display image that had been displayed till then. As a result, an image in which the hand-drawn image is not overlapped with the subcontent is displayed on whiteboard 221.

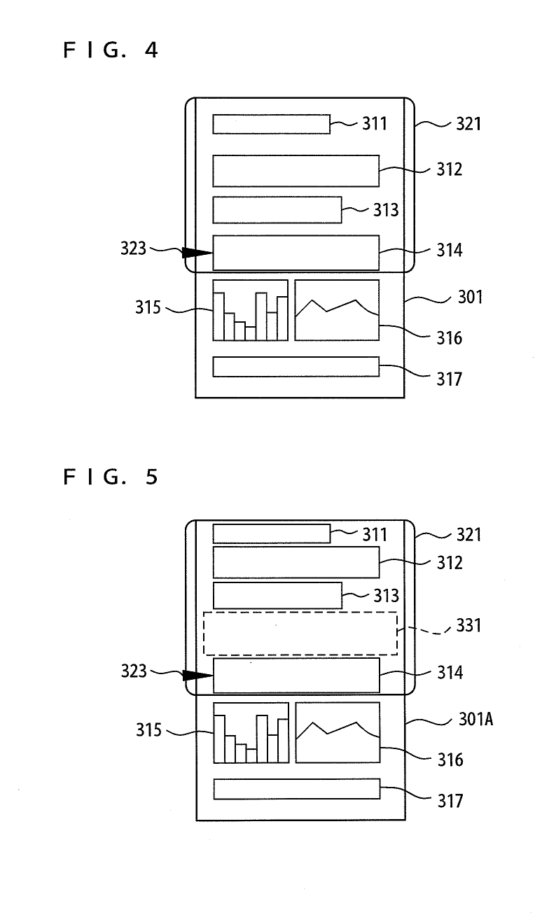

FIG. 4 is a first diagram showing an example of the relationship between display data and a display area. Referring to FIG. 4, display data 301 as a source content includes seven subcontents 311 to 317. Among them, five subcontents 311 to 314 and 317 include characters, subcontent 315 includes a graph, and subcontent 316 includes a photograph.

A display area 321 includes subcontents 311 to 314 among seven subcontents 311 to 317 included in display data 301. Display area 321 of display data 301 is projected as a display image by camera-equipped projector 210 onto whiteboard 221 to be displayed thereon. In FIG. 4, it is assumed that the automatic audio tracing function is set to ON, and a voice-recognized character string is included in a line shown by an arrow 323. The line shown by arrow 323 is included in subcontent 314, whereby subcontent 314 is determined as a target subcontent. Here, there is substantially no blank area beneath target subcontent 314 within display area 321, and accordingly, a position immediately above target subcontent 314 is determined as a layout position.

FIG. 5 is a first diagram showing an example of a modified content. The modified content shown in FIG. 5 is an example of a content generated by modifying the display data shown in FIG. 4. Referring to FIG. 5, a modified content 301A includes seven subcontents 311 to 317, as in display data 301 shown in FIG. 4. A display area 321 includes subcontents 311 to 314 among seven subcontents 311 to 317 included in modified content 301A. In display area 321, subcontent 311 is placed at the top, and subcontents 312 and 313 are placed thereunder, each at a predetermined interval. Subcontent 314 is placed at the bottom, and an insert area 331 is arranged immediately above subcontent 314.

Display portion 321 of modified content 301A includes insert area 331. Thus, when display area 321 of modified content 301A is projected as a display image onto whiteboard 221, a user can draw an image freehand on insert area 331 of the display image projected on whiteboard 221. The image drawn on whiteboard 221 comes close to target subcontent 314, allowing a user to add freehand the information regarding target subcontent 314.

Further, display area 321 of modified content 301A includes subcontents 311 to 314 as in display area 321 of display data 301 shown in FIG. 4. Thus, insert area 331 can be displayed without changing the information displayed before and after establishment of insert area 331. Furthermore, a user will readily appreciate that the position at which insert area 331 is displayed is in proximity to target subcontent 314.

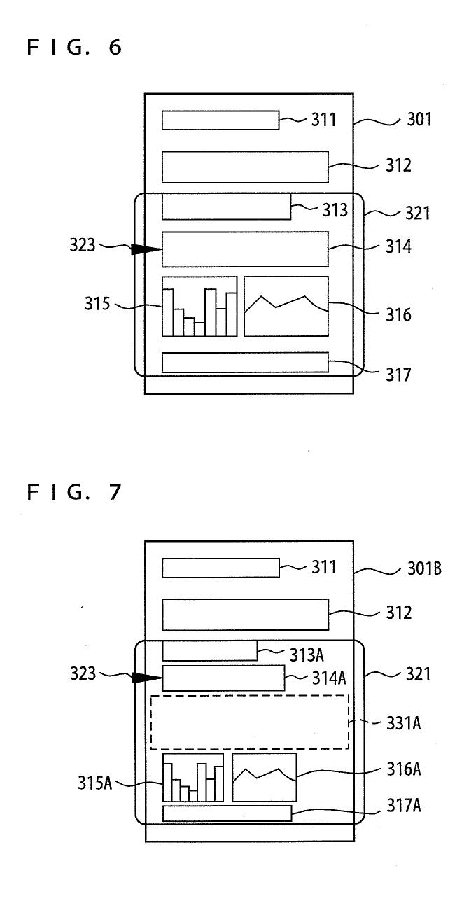

FIG. 6 is a second diagram showing an example of the relationship between the display data and the display area. Referring to FIG. 6, display data 301 as a source content includes seven subcontents 311 to 317. Among them, five subcontents 311 to 314 and 317 include characters, subcontent 315 includes a graph, and subcontent 316 includes a photograph.

A display area 321 of display data 301 includes five subcontents 313 to 317 among seven subcontents 311 to 317 included in display data 301. Display area 321 of display data 301 is projected as a display image by camera-equipped projector 210 onto whiteboard 221 to be displayed thereon. In FIG. 6, it is assumed that the automatic audio tracing function is set to ON, and a voice-recognized character string is included in a line shown by an arrow 323. The line shown by arrow 323 is included in subcontent 314, whereby subcontent 314 is determined as a target subcontent. Here, a position immediately below target subcontent 314 is determined as a layout position.

FIG. 7 is a second diagram showing an example of the modified content. The modified content shown in FIG. 7 is an example of a content generated by modifying the display data, i.e. the source content, shown in FIG. 6. Referring to FIG. 7, a modified content 301B includes subcontents 311 and 312 included in display data 301 shown in FIG. 6, and also includes subcontents 313A to 317A which are reduced versions of subcontents 313 to 317, respectively, included in display data 301.

A display area 321 of modified content 301B includes subcontents 313A to 317A among seven subcontents 311, 312, 313A to 317A included in modified content 301B. In display area 321 of modified content 301B, subcontent 313A is placed at the top, and subcontent 314A is placed thereunder at a predetermined interval. Subcontent 317A is placed at the bottom, and subcontents 315A and 316A are placed above subcontent 317A, each at a predetermined interval. An insert area 331A is arranged immediately below subcontent 314A.

Display portion 321 of modified content 301B includes insert area 331A. Thus, when display area 321 of modified content 301B is projected as a display image onto whiteboard 221, a user can draw an image freehand on insert area 331A of the display image projected on whiteboard 221. The image drawn on whiteboard 221 comes close to target subcontent 314A, allowing a user to add freehand the information regarding target subcontent 314A.

Further, display area 321 of modified content 301B includes subcontents 313A to 317A which are reduced versions of subcontents 313 to 317, respectively, included in display area 321 of display data 301 shown in FIG. 6. Thus, insert area 331A can be displayed without changing the information displayed before and after establishment of insert area 331A, although the subcontents displayed are reduced in size. Furthermore, a user will readily appreciate that the position at which insert area 331A is displayed is in proximity to target subcontent 314A reduced in size.

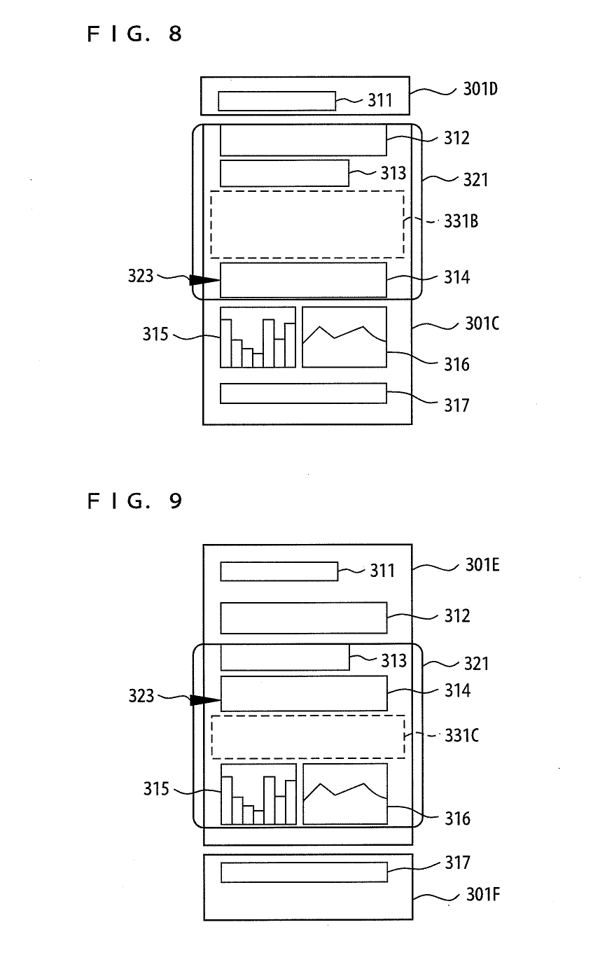

FIG. 8 is a third diagram showing an example of the modified content. Modified contents 301C and 301D shown in FIG. 8 are generated in the case where the threshold value T2, which is compared with the height of the blank area(s), is set to a value greater than that in the case where modified content 301A shown in FIG. 5 is generated. Modified contents 301C and 301D shown in FIG. 8 are examples of the modified content generated in the case where subcontent 311 included in display area 321 of display data 301, i.e. the source content, shown in FIG. 4 is to be placed outside of display area 321.

Referring first to FIG. 4, when subcontent 314 is determined to be a target subcontent in display data 301 that is the source content, a layout position is set immediately above target subcontent 314 among subcontents 311 to 314 included in display area 321 of display data 301. Further, subcontent 311 that is farthest from the layout position is placed outside of display area 321. In this case, referring to FIG. 8, a new page of page data is generated as modified content 301D, and subcontent 311 that has been excluded from display area 321 is placed in modified content 301D. Further, of the remaining subcontents 312, 313, and 314 included in display area 321 of display data 301 in FIG. 4, subcontents 312 and 313 which are located above the layout position are moved upward, while subcontents 314 which is located below the layout position is moved downward. Generated as a result is modified content 301C, shown in FIG. 8, in which a blank insert area 331B is arranged immediately above target subcontent 314.

As display area 321 of modified content 301C includes insert area 331B, when display area 321 of modified content 301C is projected as a display image onto whiteboard 221, a user can draw an image freehand on insert area 331B of the display image projected on whiteboard 221. The image drawn on whiteboard 221 comes close to target subcontent 314, allowing a user to add freehand the information regarding target subcontent 314.

Further, display area 321 of modified content 301C includes three subcontents 312 to 314 out of four subcontents 311 to 314 included in display area 321 of display data 301 shown in FIG. 4. Thus, insert area 331B can be displayed such that the information displayed is changed as little as possible before and after establishment of insert area 331B. Furthermore, a user will readily appreciate that the position at which insert area 331B is displayed is in proximity to target subcontent 314.

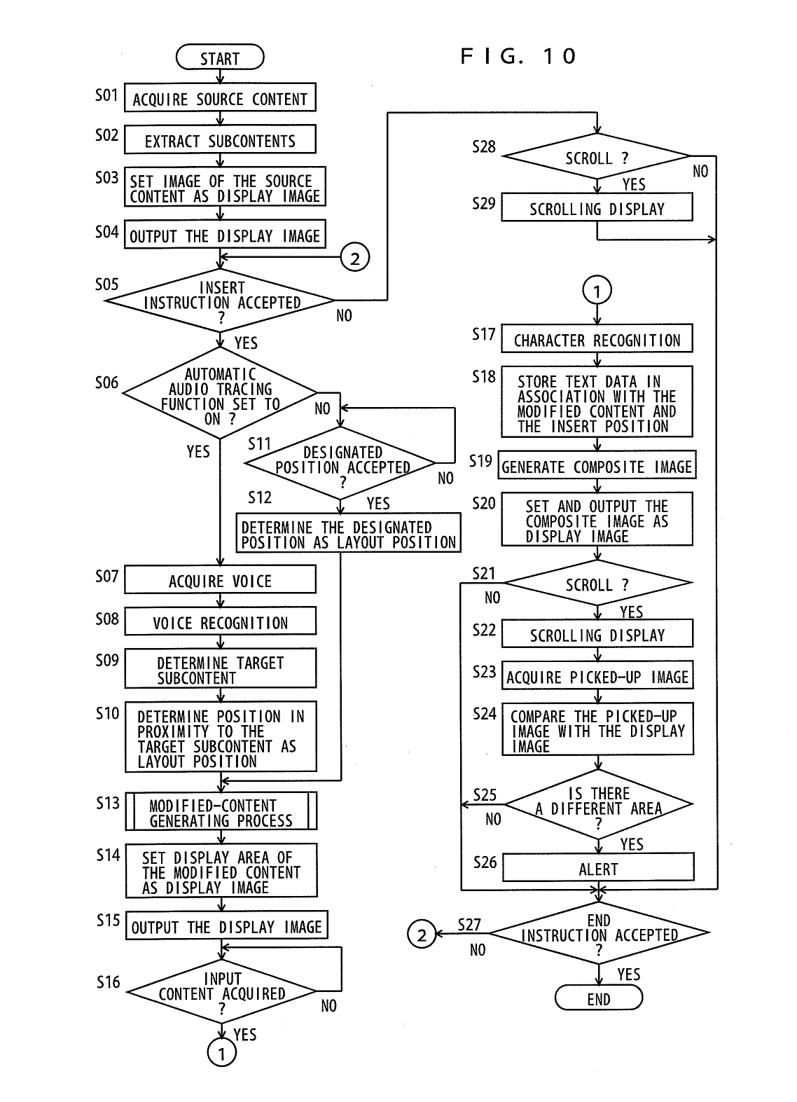

FIG. 9 is a fourth diagram showing an example of the modified content. Modified contents 301E and 301F shown in FIG. 9 are generated in the case where the threshold value T2, which is compared with the height of the blank area(s), is set to a value greater than that in the case where modified content 301B shown in FIG. 7 is generated. Modified contents 301E and 301F shown in FIG. 9 are examples of the modified content generated in the case where subcontent 317 included in display area 321 of display data 301, i.e. the source content, shown in FIG. 6 is to be placed outside of display area 321.

Referring first to FIG. 6, when subcontent 314 is determined to be a target subcontent in display data 301 that is the source content, a layout position is set immediately below target subcontent 314 among subcontents 313 to 317 included in display area 321 of display data 301. Further, subcontent 317 that is farthest from the layout position is placed outside of display area 321. In this case, referring to FIG. 9, a new page of page data is generated as modified content 301F, and subcontent 317 that has been excluded from display area 321 is placed in modified content 301F. Furthermore, of the remaining subcontents 313 to 316 included in display area 321 of display data 301 in FIG. 6, subcontents 313 and 314 which are located above the layout position are moved upward, while subcontents 315 and 316 which are located below the layout position are moved downward. Generated as a result is modified content 301E, shown in FIG. 9, in which a blank insert area 331C is arranged immediately below target subcontent 314.

As display area 321 of modified content 301E includes insert area 331C, when display area 321 of modified content 301E is projected as a display image onto whiteboard 221, a user can draw an image freehand on insert area 331C of the display image projected on whiteboard 221. The image drawn on whiteboard 221 comes close to target subcontent 314, allowing a user to add freehand the information regarding target subcontent 314.

Further, display area 321 of modified content 301E includes four subcontents 313 to 316 out of five subcontents 313 to 317 included in display area 321 of display data 301 shown in FIG. 6. Thus, insert area 331C can be displayed such that the information displayed is changed as little as possible before and after establishment of insert area 331C. Furthermore, a user will readily appreciate that the position at which insert area 331C is displayed is in proximity to target subcontent 314.

FIG. 10 shows a flowchart illustrating an example of the flow of display processing. The display processing is carried out by CPU 111 included in MFP 100 as CPU 111 executes a display program stored in ROM 113 or flash memory 119A. Referring to FIG. 10, CPU 111 acquires a source content (step S01). Specifically, CPU 111 reads display data stored in advance in HDD 116, to thereby acquire the display data as the source content. It is noted that CPU 111 may receive display data from one of PCs 200 and 200A to 200D. In the case where LAN 2 is connected to the Internet, CPU 111 may receive data from a computer connected to the Internet. The received data may be set as the source content.

In the following step S02, CPU 111 extracts subcontents from the source content acquired in step S01. Specifically, CPU 111 extracts, from the display data, each of a group of character strings, a graphic, an image, and the like included therein as the subcontent. To extract a subcontent, for example, an image of the display data is horizontally and vertically divided into a plurality of blocks. Then, an attribute is determined for each block, and neighboring blocks with the same attribute are incorporated into a single subcontent, which is in turn extracted.

In step S03, CPU 111 sets a display area of the source content as a display image. Specifically, a display area of the display data is set as the display image. The display image has a size that can be displayed by camera-equipped projector 210. Therefore, in the case where the display data is greater in size than the image that can be displayed by camera-equipped projector 210, a display area corresponding to a part of the display data is set as the display image. In the following step S04, CPU 111 outputs the display image to camera-equipped projector 210, causing the display image to be projected on whiteboard 221 so as to be displayed thereon.

In step S05, it is determined whether an insert instruction has been accepted. If so, the process proceeds to step S06; otherwise, the process proceeds to step S28. When a user performs an operation for instructing an insertion on operation portion 129B, the insert instruction is accepted. In step S06, it is determined whether an automatic audio tracing function is set to ON. The automatic audio tracing function is a function of tracing a source content, using a character string obtained by voice-recognizing the voice collected, to determine the position in the source content. The automatic audio tracing function is set to ON or OFF according to a user's setting in MFP 100 performed in advance. If the automatic audio tracing function is set to ON, the process proceeds to step S07; otherwise, the process proceeds to step S11.

In step S07, voice collected by microphone 131 is acquired. Then, the acquired voice is subjected to voice recognition (step S08). Further, on the basis of the character string obtained as a result of the voice recognition, a target subcontent is determined from among a plurality of subcontents extracted from the source content in step S02 (step S09). Specifically, the character string obtained as a result of the voice recognition is compared with character strings included respectively in the plurality of subcontents, and a subcontent including the character string that is the same as the one obtained as a result of the voice recognition is determined as a target subcontent.

In the following step S10, a position in proximity to the determined target subcontent is determined as a layout position. Here, a position immediately below or immediately above the target subcontent is determined as the layout position, and the process proceeds to step S13.

On the other hand, in step S11, CPU 111 is in a standby mode until acceptance of a designated position, and once the designated position is accepted, the process proceeds to step S12. Specifically, the display image set in step S03 is displayed on display portion 129A, and when a user inputs an arbitrary position in the display image into operation portion 129B, the position input is accepted as the designated position. The designated position thus accepted is determined as a layout position (step S12), and the process proceeds to step S13.

In step S13, a process of generating a modified content is performed, and the process proceeds to step S14. The modified-content generating process, details of which will be described later, is a process of generating a modified content in which an insert area is provided at a layout position that is determined in accordance with the position of the target subcontent in the source content. Therefore, when the modified-content generating process is performed, a modified content including an insert area is generated. Herein, the coordinates of the barycenter of the insert area arranged in the modified content represent an insert position.

In the following step S14, the display area of the modified content is set as a display image. The modified content has an insert area added to the display data. Thus, an image having the insert area added in the display area of the display data is set as the display image. In the following step S15, CPU 111 outputs the display image to camera-equipped projector 210, causing camera-equipped projector 210 to project the display image onto the whiteboard. The display image includes an image of the insert area which is a blank image. This secures a blank area on whiteboard 221, allowing a user as a presenter or a participant to draw an image freehand therein.

In step S16, CPU 111 is in a standby mode until acquisition of an input content, and once the input content is acquired, the process proceeds to step S17. Specifically, CPU 111 controls camera-equipped projector 210 to pick up the image displayed on a drawing surface of whiteboard 221, thereby acquiring a picked-up image output from camera-equipped projector 210. Further, CPU 111 specifies a portion in the picked-up image different from the display image set in step S04, and acquires the specified portion as an input content.

It is noted that, in the case where communication I/F portion 112 receives a hand-drawn image from one of PCs 200 and 200A to 200D, the received hand-drawn image may be set as an input content. Further, the input content may be an image output from original reading portion 123 that had read an original, or may be data stored in HDD 116. In these cases, when an operation for causing original reading portion 123 to read an original is input, the image output from original reading portion 123 that had read the original is acquired as the input content. When an operation of designating data stored in HDD 116 is input, the designated data is read out of HDD 116, so that the read data is acquired as the input content.

In the following step S17, the acquired input content is subjected to character recognition. Then, text data acquired as a result of the character recognition is stored in HDD 116 in association with the modified content generated and the insert position determined in step S13 (step S18).

In the following step S19, the input content acquired in step S16 is arranged at the insert position in the modified content generated in step S13 to generate a composite image. The modified content has an insert area added to the display data. Therefore, the hand-drawn image is fitted into the insert area. Then, the display area of the composite image is set and output as a display image (step S20).

In the following step S21, it is determined whether a scroll instruction has been accepted. If so, the process proceeds to step S22; otherwise, the process proceeds to step S27. In step S27, it is determined whether an end instruction has been accepted. If so, the process is terminated; otherwise, the process returns to step S05.

In step S22, CPU 111 switches the display image in accordance with the scroll operation to perform a scrolling display, and the process proceeds to step S23. When the scroll operation is an instruction for displaying an image above the display image, an area in the composite image that is above the display area currently set to be the display image is newly set as a display area, which is in turn set as a new display image. When the scroll operation is an instruction for displaying an image below the display image, an area in the composite image that is below the display area currently set to be the display image is newly set as a display area, which is in turn set as a new display image. The display image of the display area of the composite image is projected by camera-equipped projector 210 onto whiteboard 221 to be displayed thereon.

In step S23, CPU 111 acquires a picked-up image. Specifically, CPU 111 acquires from camera-equipped projector 210 an image picked up by camera 211 included in camera-equipped projector 210. CPU 111 then compares the picked-up image with the display image (step S24). If there is a difference between the display image and the picked-up image (YES in step S25), the process proceeds to step S26; otherwise (NO in step S25), the process proceeds to step S27, with step S26 being skipped.

In step S26, a user is alerted, and the process proceeds to step S27. The alert is a notification indicating that the handwritten character remains on whiteboard 221. For example, CPU 111 causes camera-equipped projector 210 to display a message: “Please erase the hand-drawn image on the whiteboard.” Alternatively, an audible alarm may be generated.

On the other hand, the process proceeds to step S28 if an insert instruction has not been accepted from a user. In this case, in step S28, it is determined whether a scroll instruction has been accepted. If so, the process proceeds to step S29; otherwise, the process proceeds to step S27 with step S29 skipped. In step S29, the scrolling display is performed, and the process proceeds to step S27. In the scrolling display, the display image is switched in accordance with a scroll operation, so that a new display image is displayed. When the scroll operation is an instruction for displaying an image above the display image, an area in the display data that is above the current display area is newly set as a display area. When the scroll operation is an instruction for displaying an image below the display image, an area in the display data that is below the current display area is newly set as a display area. In step S27, it is determined whether an end instruction has been accepted. If so, the process is terminated; otherwise, the process returns to step S05.

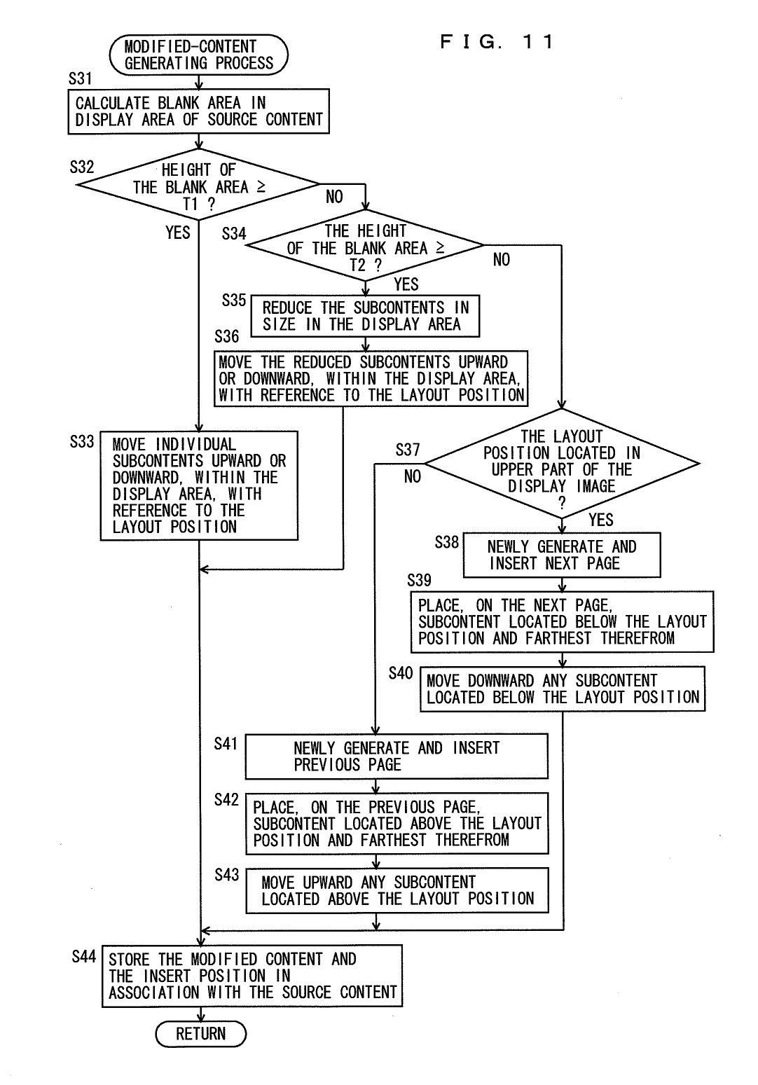

FIG. 11 is a flowchart illustrating an example of the flow of the modified-content generating process, which is executed in step S13 in FIG. 10. Referring to FIG. 11, CPU 111 calculates a blank area in the source content (step S31). Herein, a plurality of subcontents are arrayed in the vertical direction. Thus, a length in the vertical direction of a blank area included in the display area of the display data as the source content is calculated. In the case where there is more than one blank area, a total length in the vertical direction of the blank areas is calculated.

It is then determined whether the total height of the blank areas is a threshold value T1 or more (step S32). If so, the process proceeds to step S33; otherwise, the process proceeds to step S34. In step S33, the individual subcontents are moved upward or downward, inside the display area, with reference to the layout position in the source content, to generate a modified content. The process then proceeds to step S44.

In step S34, it is determined whether the total height of the blank areas is a threshold value T2 or more. If so, the process proceeds to step S35; otherwise, the process proceeds to step S37. In step S35, a plurality of subcontents included in the display area of the source content are reduced in size. Then, the reduced subcontents are moved upward or downward, in the display area, with reference to the layout position, to generate a modified content (step S36), and the process proceeds to step S44.

In step S37, it is determined whether the layout position is located in an upper part of the display image. If the layout position is above the center in the vertical direction of the display image, it is determined that the layout position is located in an upper part of the display image. If so, the process proceeds to step S38; otherwise, the process proceeds to step S41. In step S38, page data of a succeeding, or, next page is newly generated and added to the source content. The page data of the next page which is newly generated is a blank page. In the following step S39, a subcontent that is located below the layout position and farthest therefrom is placed in the page data of the next page newly generated. In the following step S40, any subcontent located below the layout position is moved downward, and the process proceeds to step S44. Specifically, one or more subcontents located below the layout position are moved downward until the subcontent that is located at the lowest position among those included in the display area is placed outside of the display area. This allows an insert area to be secured below the layout position.

In step S41, page data of a preceding, or, previous page is newly generated and added to the source content, similarly as in step S38. The page data of the previous page which is newly generated is a blank page. In the following step S42, a subcontent that is located above the layout position and farthest therefrom is placed in the page data of the previous page newly generated. In the following step S43, any subcontent located above the layout position is moved upward, and the process proceeds to step S44. Specifically, one or more subcontents located above the layout position are moved upward until the subcontent that is located at the highest position among those included in the display area is placed outside of the display area. As a result, an insert area is secured above the layout position.

In step S44, the modified content generated in step S33, S36, S40, or S43 and its insert position are stored in HDD 116 in association with the source content, and the process returns to the display processing. The insert position refers to the coordinates of the barycenter of the insert area included in the modified content.

### Second Embodiment

In conference system 1 according to the first embodiment, a target subcontent is determined by the automatic audio tracing function or in accordance with a designated position input to MFP 100 by a user. In a conference system 1 according to a second embodiment, a target subcontent is determined on the basis of an image that a conference presenter or a conference participant draws freehand with a pen or the like on whiteboard 221. In this case, the automatic audio tracing function used in conference system 1 according to the first embodiment is unnecessary, and it is also unnecessary to accept a user input of a designated position.

The overall configuration of the conference system according to the second embodiment is identical to that shown in FIG. 1, and the hardware configuration of MFP 100 is identical to that shown in FIG. 2.

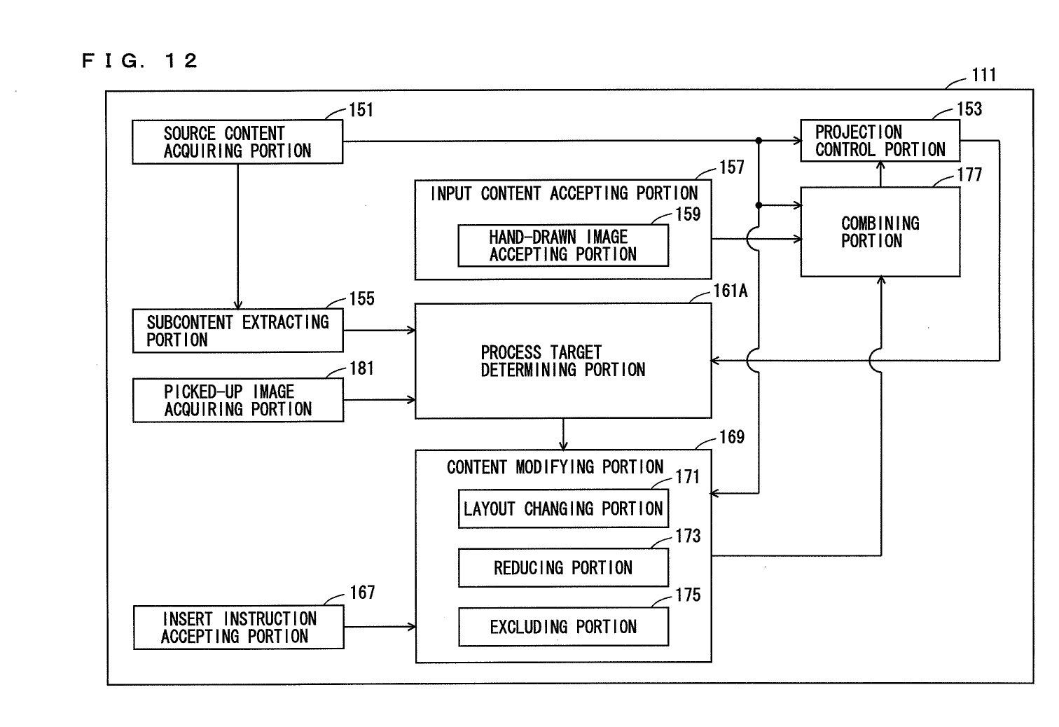

FIG. 12 is a block diagram schematically showing the functions of the CPU included in the MFP according to the second embodiment. The functions shown in FIG. 12 are implemented as CPU 111 included in MFP 100 executes a display program stored in ROM 113 or flash memory 119A. Referring to FIG. 12, it is different from the block diagram shown in FIG. 3 in that process target determining portion 161 has been changed to a process target determining portion 161A, and a picked-up image acquiring portion 181 has been added. The other functions are similar to those shown in FIG. 3, and thus, description thereof will not be repeated here.

Picked-up image acquiring portion 181 controls camera-equipped projector 210 via communication I/F portion 112 to acquire an image picked up by camera 211, and outputs the acquired, picked-up image to process target determining portion 161A.

Process target determining portion 161A receives a picked-up image from picked-up image acquiring portion 181, a display image from projection control portion 153, and a subcontent from subcontent extracting portion 155. When receiving a plurality of subcontents from subcontent extracting portion 155, process target determining portion 161A determines a target subcontent from among the plurality of subcontents. Specifically, process target determining portion 161A compares the picked-up image with the display image to extract a difference image which is included in the picked-up image but not included in the display image.

Process target determining portion 161A then compares the hue of the difference image with that of an area in the display image corresponding to the difference image. If the difference between the hues is a predetermined threshold value TC or less, process target determining portion 161A determines a target subcontent. If the difference between the hues exceeds the predetermined threshold value TC, process target determining portion 161A does not determine a target subcontent. Specifically, in the case where the color of the difference image and the color of the corresponding area in the display image are identical or similar in terms of hue, process target determining portion 161A determines one of the plurality of subcontents that is located at the same position as that of the difference image, or located in the vicinity of that of the difference image, as a target subcontent. Process target determining portion 161A outputs the positional information of the target subcontent to content modifying portion 169.

When the difference between the hue of the display image and that of the difference image is the predetermined threshold value TC or less, the pen used by a presenter or a participant to draw the image on whiteboard 221 is identical or similar in terms of hue to the display image. In this case, it can be considered that the presenter or the participant has drawn a memorandum on whiteboard 221 with the pen. As process target determining portion 161A outputs the positional information of the target subcontent to content modifying portion 169, content modifying portion 169 generates a modified content in which an insert area is secured such that the image added by the presenter or the participant is not overlapped with the display image.

On the other hand, when the difference between the hue of the display image and that of the difference image exceeds the predetermined threshold value TC, it means that the pen used by a presenter or a participant to draw the image on whiteboard 221 is different in terms of hue from the display image. In this case, it can be considered that the presenter or the participant has drawn supplemental remarks on the display image, on whiteboard 221 with the pen. As process target determining portion 161A does not output positional information of a target subcontent to content modifying portion 169, the display image is displayed as it is, with the state in which the drawn image is overlaid on the display image being maintained.

Therefore, a presenter or a participant can determine whether to cause a modified content to be generated or not, by selecting a color of the pen used for drawing an image on whiteboard 221.

FIG. 13 shows an example of display data and picked-up images. Referring to FIG. 13, display data 301 as a soured content and a display area 321 are identical to display data 301 and display area 321, respectively, shown in FIG. 6, except that picked-up images 351 and 352 are included in display area 321. Picked-up image 351 includes a character string “down”, which is identical in terms of hue to subcontent 315. Picked-up image 352 includes a character string “pending”, which is different in terms of hue from subcontent 314. It is noted that, although picked-up images 351 and 352 are delimited by broken lines, the broken lines do not actually exist. In this case, subcontent 315 is determined as a target subcontent. It is here assumed that the layout position is set immediately above subcontent 315.

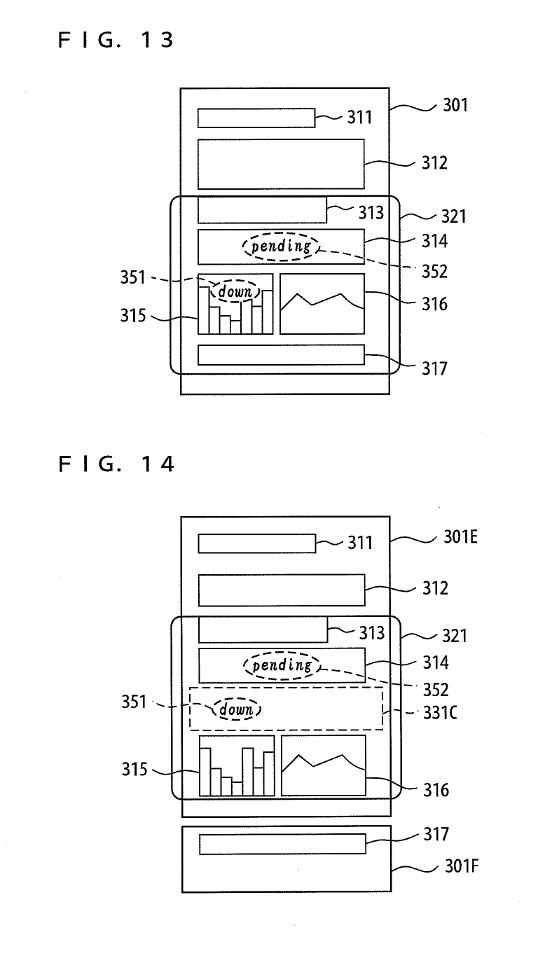

FIG. 14 is a fifth diagram showing an example of the modified content. The modified content shown in FIG. 14 is an example of a content generated by modifying display data 301 as the source content shown in FIG. 13. Referring to FIG. 14, modified contents 301E and 301F are identical to modified contents 301E and 301F, respectively, shown in FIG. 9. That is, page data of a new page is generated as modified content 301F, and subcontent 317 excluded from display area 321 is placed in modified content 301F. Furthermore, of the remaining subcontents 313 to 316 included in display area 321 of display data 301 in FIG. 13, subcontents 313 and 314 which are located above the layout position that has been set immediately above target subcontent 315 are moved upward, while subcontents 315 and 316 which are located below the layout position are moved downward, to thereby generate modified content 301E in which a blank insert area 331C is arranged immediately above target subcontent 315, as shown in FIG. 14.

Display area 321 of modified content 301E includes subcontents 313 to 316 among six subcontents 311 to 316 included in modified content 301E. In display area 321 of modified content 301E, subcontent 313 is placed at the top, subcontent 314 is placed under subcontent 313 at a predetermined interval, subcontents 315 and 316 are placed at the bottom, at the predetermined interval, and insert area 331C is placed immediately above subcontent 315.

Even after display data 301 is modified to modified contents 301E and 301F, when display area 321 of modified content 301E is projected onto whiteboard 221 as a display image, positions of picked-up images 351 and 352 in display area 321 are not changed, causing picked-up image 352 to remain overlaid on subcontent 314. Picked-up image 352, however, is different in terms of hue from subcontent 314, allowing a user to distinguish picked-up image 352 from subcontent 314. On the other hand, picked-up image 351 is arranged in insert area 331C of modified content 301E, so that a user can distinguish picked-up image 351 from subcontent 315 even though the character string “down” of picked-up image 351 is identical in terms of hue to subcontent 315.

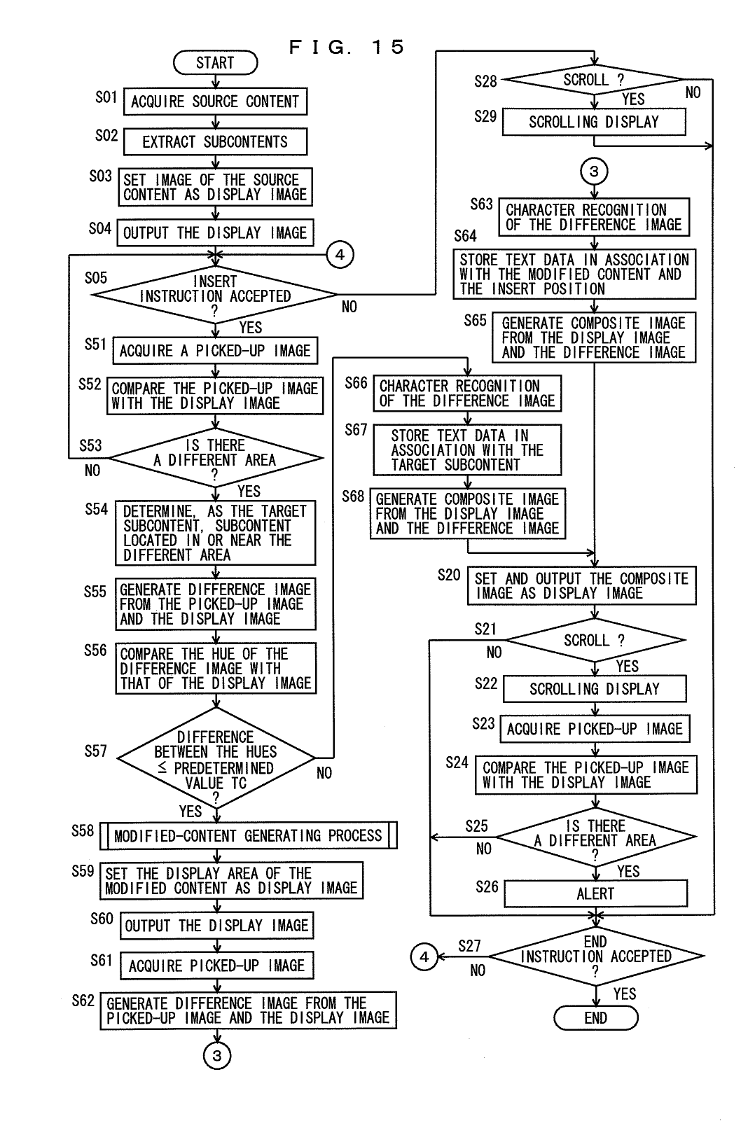

FIG. 15 shows a second flowchart illustrating an example of the flow of the display processing. The display processing is carried out by CPU 111 included in MFP 100 according to the second embodiment as CPU 111 executes a display program stored in ROM 113 or flash memory 119A. Referring to FIG. 15, the flowchart is different from that shown in FIG. 10 in that steps S51 to S68 are executed in place of steps S06 to S19. Steps S01 to S05 and S20 to S29 are identical to those shown in FIG. 10, and thus, description thereof will not be repeated here.

If the insert instruction is accepted in step S05, in step S51, CPU 111 causes camera-equipped projector 210 to pick up an image on whiteboard 221, and acquires from camera-equipped projector 210 the picked-up image picked up by camera 211.

Then, CPU 111 compares the picked-up image acquired in step S51 with the display image output to camera-equipped projector 210 in step S04 or S29 (step S52). In the following step S53, it is determined whether there is a different area between the display image and the picked-up image. If so, the process proceeds to step S54; otherwise, the process returns to step S05.

In step S54, a subcontent that is located in the different area between the display image and the picked-up image, or a subcontent that is located near the different area, is determined as a target subcontent. Further, a difference image is generated from the picked-up image and the display image (step S55). The difference image and the display image are compared with each other. Specifically, the hue of the difference image is compared with the hue of the area in the display image corresponding to the difference image (step S56). It is then determined whether the difference between the hues is a predetermined threshold value TC or less. If so (YES in step S57), the process proceeds to step S58; otherwise (NO in step S57), the process proceeds to step S66.

In step S58, the modified-content generating process shown in FIG. 11 is executed, and the process proceeds to step S59. In step S59, the display area of the modified content is set as a display image. In the following step S60, CPU 111 outputs the display image to camera-equipped projector 210 to cause it to project the display image onto whiteboard 221. The display image includes an image of the insert area which is a blank image, so that a user as a presenter or a participant can see an image in which the image drawn on whiteboard 221 is not overlapped with the display image.

In step S61, a picked-up image is acquired. Specifically, the image picked up by camera 211 of camera-equipped projector 210 is acquired from camera-equipped projector 210. Then, a difference image is generated on the basis of the display image and the picked-up image (step S62). The difference image is an image included in the picked-up image but not included in the display image. That is, it includes an image added freehand onto whiteboard 221. In the following step S63, the difference image is subjected to character recognition. This allows characters in the difference image to be acquired as text data.

The text data acquired as a result of the character recognition is stored in HDD 116 in association with the modified content generated and the insert position determined in step S58 (step S64). In the following step S65, the difference image is combined with the display image to generate a composite image, and the process proceeds to step S20. The display area of the modified content has been set as the display image in step S59, while the difference image includes the image added freehand onto whiteboard 221 by a presenter or a participant. Accordingly, the composite image is an image in which the hand-drawn image is combined with the modified content. The modified content includes an insert area in the area that is superposed on the hand-drawn image, so that a composite image is generated in which the hand-drawn image is not superposed on other subcontents. In the following step S20, the composite image is set as a new display image, and is output to camera-equipped projector 210 to be displayed on whiteboard 221.

On the other hand, in step S66, the difference image is subjected to character recognition, as in step S63. In the following step S67, the text data acquired as a result of the character recognition is stored in HDD 116 in association with the subcontent that has been determined as the target subcontent in step S54. Further, the display image is combined with the difference image to generate a composite image (step S68), and the process proceeds to step S20. In the following step S20, the composite image is set as a new display image, and is output to camera-equipped projector 210 to be displayed on whiteboard 221. In the case where the process proceeds from step S68, the display area of the composite image being displayed is an image in which the hand-drawn image is combined with the display data. In this case, the target subcontent and the hand-drawn image are different in terms of hue from each other, and therefore, even if they overlap each other, a presenter or a participant can differentiate between the target subcontent and the hand-drawn image to distinguish them from each other.

### <Modifications of Modified Content>

Modifications of the modified content will now be described. FIG. 16 is a third diagram showing an example of the relationship between the display data and the display area. Referring to FIG. 16, display data 351 as a source content includes six subcontents 361 to 366. Among them, four subcontents 361 to 364 include characters, subcontent 365 includes a graph, and subcontent 366 includes a photograph.

A display area 321 is identical in size to display data 351, and includes the entirety of display data 351. In FIG. 16, it is assumed that the automatic audio tracing function is set to ON, and a voice-recognized character string is included in a line indicated by an arrow 323. The line indicated by arrow 323 is included in subcontent 364, whereby subcontent 364 is determined as a target subcontent. Here, there is substantially no blank area under target subcontent 364, and accordingly, a position above target subcontent 364 is determined as a layout position.

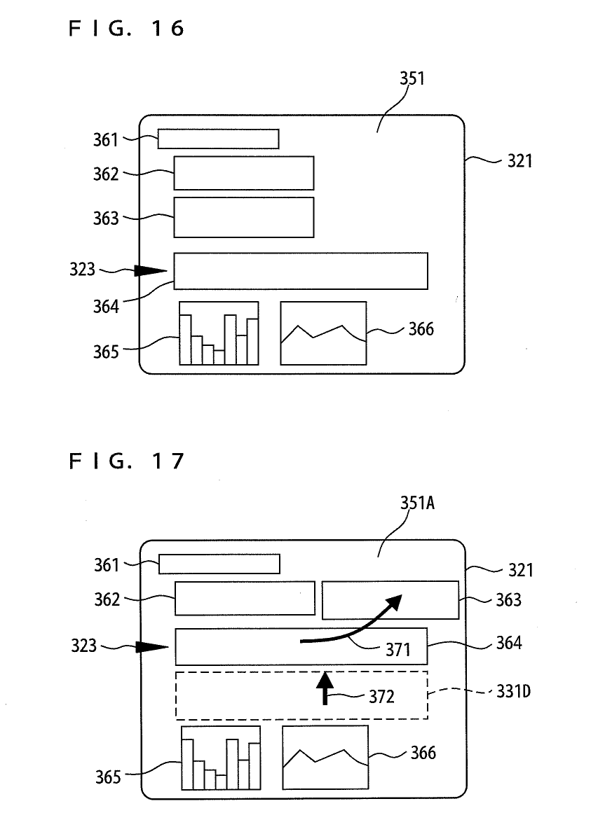

FIG. 17 is a sixth diagram showing an example of the modified content. The modified content shown in FIG. 17 is an example of a content generated by modifying the display data shown in FIG. 16. Referring to FIG. 17, while a modified content 351A includes six subcontents 361 to 366, as in display data 351 shown in FIG. 16, the positions of two subcontents 363 and 364 in modified content 351A have been changed from those in display data 351. Specifically, subcontent 363 is placed to the right of subcontents 361 and 362, and subcontent 364 is placed at the position where subcontent 363 was originally placed. Further, modified content 351A includes an insert area 331D at the position where subcontent 364 was originally placed, and includes an arrow 371 indicating that subcontent 363 has been moved, and an arrow 372 indicating that subcontent 364 has been moved.

As modified content 351A includes insert area 331D, when modified content 351A is projected as a display image onto whiteboard 221, a user can draw an image freehand on insert area 331D of the display image projected onto whiteboard 221. Further, the image drawn on whiteboard 221 comes close to target subcontent 364, allowing a user to add freehand the information regarding target subcontent 364.

Further, modified content 351A includes subcontents 361 to 366 as in display data 351 shown in FIG. 16. Thus, insert area 331D can be displayed without changing information displayed before and after establishment of insert area 331D. Furthermore, a user will readily appreciate that the position at which insert area 331D is displayed is in proximity to target subcontent 364.

Furthermore, modified content 351A includes arrows 371 and 372. Thus, a user will readily understand a difference between display data 351 and modified content 351A.

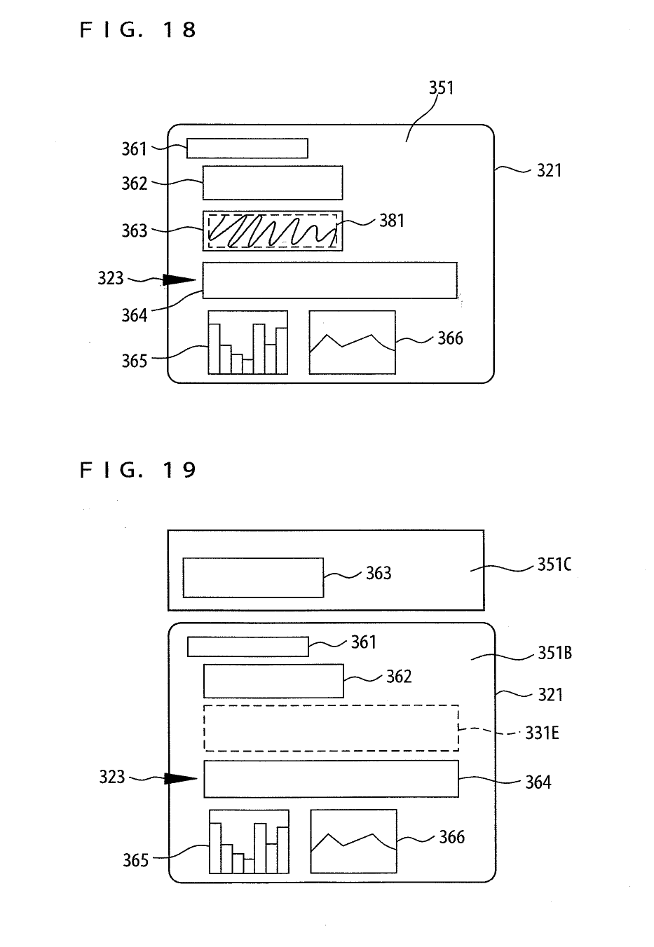

FIG. 18 shows an example of display data and a hand-drawn image. Referring to FIG. 18, display data 351 as a source content and a display area 321 are identical to display data 351 and display area 321, respectively, shown in FIG. 16, except that a hand-drawn image 381 is included in display area 321. Hand-drawn image 381 is identical to a picked-up image. Hand-drawn image 381 includes an image which masks subcontent 363, and is identical in terms of hue to subcontent 363. Here, hand-drawn image 381 is shown as a line image overlaid on subcontent 363. It is noted that, although hand-drawn image 381 is delimited by broken lines, the broken lines do not actually exist.

In FIG. 18, it is assumed that the automatic audio tracing function is set to ON, and a voice-recognized character string is included in a line indicated by an arrow 323. The line indicated by arrow 323 is included in subcontent 364, whereby subcontent 364 is determined as a target subcontent. Here, a position immediately above target subcontent 364 is determined as a layout position.

FIG. 19 is a seventh diagram showing an example of the modified content. The modified content shown in FIG. 19 is an example of a content generated by modifying the display data shown in FIG. 18. Referring first to FIG. 18, of subcontents 361 to 366 included in display data 351, target subcontent 363 that is masked by hand-drawn image 381 is placed outside of display area 321. In this case, referring to FIG. 19, page data of a new page is generated as a modified content 351C, and subcontent 363 excluded from display area 321 is placed in modified content 351C. Further, a modified content 351B is generated in which an insert area 331E is placed at the position where subcontent 363 was originally placed in FIG. 18.

As described above, according to conference system 1 of the first embodiment, in MFP 100, a plurality of subcontents are extracted from display data which is a source content, a target subcontent is determined from among the plurality of subcontents, a modified content is generated in which an insert area for arranging a hand-drawn image (i.e. an input content) therein is added at a position in the display data that is determined with reference to a layout position in proximity to the target subcontent, and a composite image having the hand-drawn image arranged in the insert area added to the modified content is displayed by camera-equipped projector 210. This allows a hand-drawn image to be arranged such that it is not overlapped with a subcontent included in the display data, without changing the information included in the display area of the display data.

Content modifying portion 169 includes layout changing portion 171, which changes the layout of a plurality of subcontents included in the display area of the display data. While the layout of the subcontents displayed is changed, there is no change in the displayed information before and after the change of the layout. As a result, a hand-drawn image can be arranged without changing the displayed information of the display data.

Content modifying portion 169 also includes reducing portion 173, which reduces the subcontents included in the display area of the display data and then changes the layout of the subcontents reduced in size. While the subcontents being displayed are reduced in size and their layout is changed, there is no change in the displayed information before and after the reduction and the change of the layout. As a result, a hand-drawn image can be arranged without changing the displayed information of the display data.

Content modifying portion 169 further includes excluding portion 175, which causes at least one of the subcontents included in the display area of the display data to be placed outside of the display area, and then changes the layout of the remaining subcontents. The layout of the subcontents is changed, with as many subcontents as possible being kept displayed, so that the displayed information is changed as little as possible before and after the change of the layout. As a result, a hand-drawn image can be arranged, while minimizing the change in the displayed information of the display data.

Further, MFP 100 according to the second embodiment determines, as the target subcontent, one of the plurality of subcontents included in the display data that is located at an area overlapped with the hand-drawn image within the display image. This can make the subcontent overlapped with the hand-drawn image readily distinguishable.

Furthermore, MFP 100 stores the display data (i.e. the source content), the modified content, and the hand-drawn image (i.e. the input content) in association with one another. MFP 100 stores the hand-drawn image in further association with an insert position in the modified content at which the hand-drawn image is to be placed, and with the position in the source content at which the target subcontent is located. This enables a composite image to be reproduced from the display data, the modified content, and the hand-drawn image.

While conference system 1 and MFP 100 as an example of the information processing apparatus have been described in the above embodiments, the present invention may of course be understood as a display method for causing MFP 100 to carry out the processing illustrated in FIGS. 10 and 11, or FIG. 15, or as a display program for causing CPU 111 controlling MFP 100 to carry out the display method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A conference system including a display apparatus and an information processing apparatus capable of communicating with the display apparatus,
said information processing apparatus comprising:
a source content acquiring portion to acquire a source content;
a display control portion to cause said display apparatus to display said acquired source content;
a subcontent extracting portion to extract a plurality of subcontents included in said acquired source content;
a process target determining portion to determine a target subcontent from among said plurality of extracted subcontents;
an input content accepting portion to accept an input content input externally; and
a content modifying portion to generate a modified content in which an insert area for arranging said input content therein is added at a position in said source content that is determined with reference to a position where said target subcontent is located;
said display control portion causing said display apparatus to display an image in which said input content is arranged in said added insert area in said modified content.

2. The conference system according to claim 1, wherein said content modifying portion includes a layout changing portion to change the layout of at least one of said plurality of subcontents included in said source content.

3. The conference system according to claim 2, wherein said layout changing portion changes the layout of a plurality of subcontents displayed by said display apparatus, among said plurality of subcontents included in said source content.

4. The conference system according to claim 3, wherein said layout changing portion reduces an interval between the plurality of subcontents displayed by said display apparatus.

5. The conference system according to claim 1, wherein said content modifying portion includes a reducing portion to reduce the size of at least one of said plurality of subcontents included in said source content.

6. The conference system according to claim 5, wherein said reducing portion reduces the sizes of a plurality of subcontents displayed by said display apparatus.

7. The conference system according to claim 1, wherein said content modifying portion includes an excluding portion to exclude, from a display area, at least one of a plurality of subcontents displayed by said display apparatus, among said plurality of subcontents included in said source content.

8. The conference system according to claim 1, wherein said input content accepting portion includes a hand-drawn image accepting portion to accept a hand-drawn image.

9. The conference system according to claim 8, wherein
said display control portion displays an image of said source content, and
said process target determining portion determines, as the target subcontent, one of said plurality of subcontents that is located at an area in which the hand-drawn image accepted by said input content accepting portion is overlapped with the image of said source content displayed by said display control portion.

10. The conference system according to claim 1, wherein said information processing apparatus further comprises a content storing portion to store said source content, said modified content, and said input content in association with one another,
said content storing portion storing said input content in further association with an insert position in said modified content at which the input content is to be placed, and with the position in said source content at which said target subcontent is located.

11. The conference system according to claim 1, wherein
said process target determining portion includes
a voice accepting portion to accept voice from the outside and
a voice recognition portion to recognize said accepted voice, and
said process target determining portion determines, as the target subcontent, one of said plurality of subcontents that includes a character string selected from said recognized voice.

12. An information processing apparatus capable of communicating with a display apparatus, said information processing apparatus comprising:
a source content acquiring portion to acquire a source content;
a display control portion to cause said display apparatus to display said acquired source content;
a subcontent extracting portion to extract a plurality of subcontents included in said acquired source content;
a process target determining portion to determine a target subcontent as a process target from among said plurality of extracted subcontents;
an input content accepting portion to accept an input content input externally; and
a content modifying portion to generate a modified content in which an insert area for arranging said input content therein is added at a position in said source content that is determined with reference to a position where said target subcontent is located;
said display control portion causing said display apparatus to display an image in which said input content is arranged in said added insert area in said modified content.

13. A display method executed by an information processing apparatus capable of communicating with a display apparatus, said display method comprising steps of:
acquiring a source content;
causing said display apparatus to display said acquired source content;
extracting a plurality of subcontents included in said acquired source content;
determining a target subcontent as a process target from among said plurality of extracted subcontents;
accepting an input content input externally;
generating a modified content in which an insert area for arranging said input content therein is added at a position in said source content that is determined with reference to a position where said target subcontent is located; and
causing said display apparatus to display an image in which said input content is arranged in said added insert area in said modified content.

14. A non-transitory computer-readable recording medium encoded with a display program executed by a computer controlling an information processing apparatus, the information processing apparatus capable of communicating with a display apparatus,
said display program causing said computer to execute processing comprising steps of:
acquiring a source content;
causing said display apparatus to display said acquired source content;
extracting a plurality of subcontents included in said acquired source content;
determining a target subcontent as a process target from among said plurality of extracted subcontents;
accepting an input content input externally;
generating a modified content in which an insert area for arranging said input content therein is added at a position in said source content that is determined with reference to a position where said target subcontent is located; and
causing said display apparatus to display an image in which said input content is arranged in said added insert area in said modified content.
